(19) United States
(12) Patent Application Publication
(10) Pub. No.: US 2013/0142520 A1
(43) Pub. Date: Jun. 6, 2013

(54) ANTI-CAUSAL PRE-EMPHASIS FOR HIGH SPEED OPTICAL TRANSMISSION

(71) Applicant: Chuan Xie, San Jose, CA (US)

(72) Inventor: Chuan Xie, San Jose, CA (US)

(21) Appl. No.: 12/165,433

(22) Filed: Jun. 30, 2008

(51) Int. Cl. H04B 10/2507

(52) U.S. Cl. CPC H04B 10/2507
USPC 398/193

(57) ABSTRACT

When a high data rate optical signal travels through a fiber link, its high frequency components tend to experience higher losses due to fiber dispersion (modal and/or chromatic). The loss of high frequency components causes the optical eye to close and the sensitivity to degrade. Disclosed is an apparatus and method for an optical transmitter that relies on anti-causal pre-emphasis to counteract the effect of relaxation oscillation, and therefore brings improvements to optical eye symmetry and mask margin (MM).

### FIELD OF THE INVENTION

Embodiments of the present invention are directed to high speed optical transmission and, more particularly, to an anti-causal pre-emphasis scheme to improve transmission characteristics.

### BACKGROUND INFORMATION

When a high data rate optical signal travels thru a fiber link, its high frequency components tend to experience higher losses due to fiber dispersion (modal and/or chromatic). The loss of high frequency components causes the optical eye to close and the sensitivity to degrade.

Optical eye diagrams are visual tools that are useful to quickly visually assess the quality of a digital signal. Eye diagrams show parametric information for a signal containing every possible bit sequence by ascertaining rise times, fall times, jitter at the middle of the crossing point of the eye, any overshoot present and many other numerical descriptions of eye behavior.

One common way to lower dispersion induced link penalty is to boost the high frequency contents of the signal using transmission (Tx) pre-emphasis. Simply put, pre-emphasis is a method wherein the waveform of an input data signal is purposely distorted, at a transmitting end in consideration of signal attenuation and other distortion characteristics likely to occur to the signal as it traverses the transmission medium (e.g. a fiber), such that the waveform arriving at the receiving end remains optimized.

Conventional Tx pre-emphasis may be done with passive (i.e. causal) filtering but has a drawback as it degrades the optical eye mask margin (MM) and due to laser relaxation oscillation 10 Gbps optical eyes tend to lack left-right symmetry. FIG. 1A shows an example of an optical eye without pre-emphasis showing weak corners for the mask. FIG. 1B shows the optical eye having for the signal with pre-emphasis which tends to further degrade the mask corners.

### BRIEF DESCRIPTION OF THE DRAWINGS

The foregoing and a better understanding of the present invention may become apparent from the following detailed description of arrangements and example embodiments and the claims when read in connection with the accompanying drawings, all forming a part of the disclosure of this invention. While the foregoing and following written and illustrated disclosure focuses on disclosing arrangements and example embodiments of the invention, it should be clearly understood that the same is by way of illustration and example only and the invention is not limited thereto.

FIG. 1A is an optical eye diagram without conventional Tx pre-emphasis;

FIG. 1B is an optical eye diagram with conventional Tx pre-emphasis;

FIG. 2 is a diagram illustrating creating pre-emphasis by combining a signal with a fraction if its delayed inversion;

FIG. 3A is a waveform with pre-emphasis;

FIG. 3B is an optical eye diagram with causal pre-emphasis;

FIG. 3C is a waveform with anti-causal pre-emphasis;

FIG. 3D is an optical eye diagram with anti-casual pre-emphasis;

FIGS. 4A and 48 are diagrams showing causal and anti-causal, same magnitude, complementary phase and group delay;

FIG. 5A is a diagram showing transfer function (log magnitude) of pre-emphasis verses a and T;

FIGS. 5B and 5C show optical eye diagrams having different pre-emphasis;

FIGS. 6A is a diagram showing PRBS pattern spectra with a different pre-emphasis;

FIGS. 6B and 6C show optical eye diagrams having different pre-emphasis;

FIGS. 7A is a diagram showing the same as FIG. 6A but for a wider frequency range;

FIGS. 7B and 7C show optical eye diagrams having different pre-emphasis;

FIG. 8 is a block diagram of an anti-causal pre-emphasis TX laser system;

FIG. 9 shows waveforms with and without anti-causal pre-emphasis; and

FIG. 10 shows optical eye diagrams with and without anti-causal pre-emphasis.

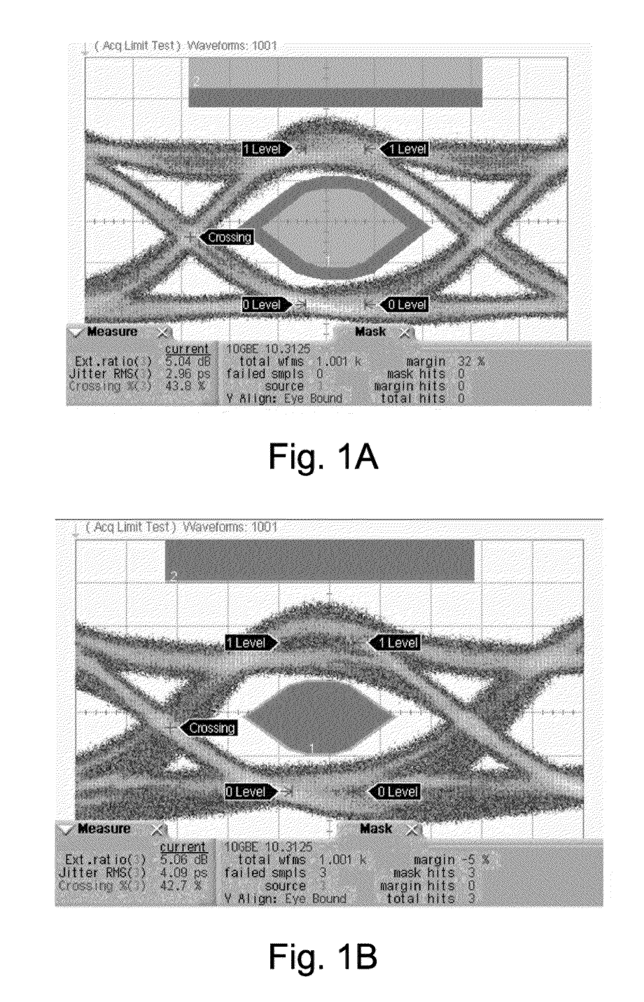

### DETAILED DESCRIPTION

Described is a novel method of Tx pre-emphasis wherein it boosts the high frequency components of the signal and improves eye symmetry along with MM. Such pre-emphasis is done through signal processing, as is described below instead of passive filtering.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As noted above, conventional Tx pre-emphasis may be done with passive (i.e. causal) filtering. By way of brief overview, in signal processing, a causal filter is a linear and time-invariant causal system. The word causal indicates that the filter output depends only on past and present inputs. A filter whose output also depends on future inputs is a causal. A filter whose output depends only on future inputs is generally considered anti-causal.

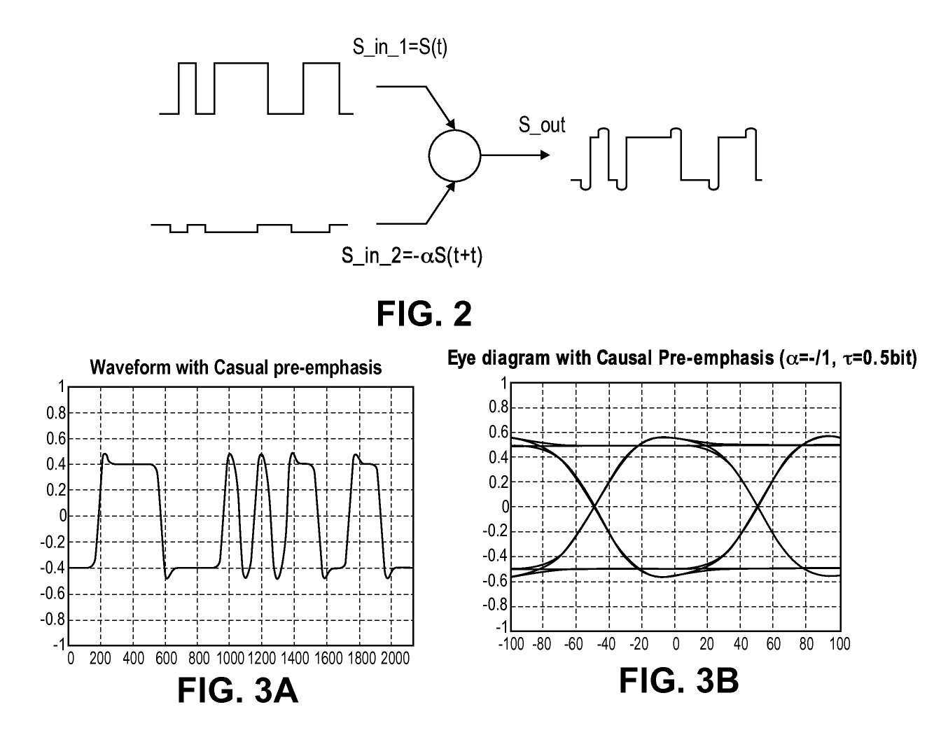

Referring now to FIG. 2, the sum of a (binary) signal (S_in_{—}1=S(t)) and a fraction of its inversion (S_in_2) results in an output signal (S_out) with pre-emphasis when the two constituent signals have relative delay. Note, the second input signal (S_in_2) comprises the first input signal S(t) with its amplitude reduced by a factor alpha (α) and a time delay factor (τ) thus yielding S_in_{—}2=αS(T+τ). Two parameters completely characterize this pre-emphasis. That is, the weak to strong signal amplitude ratio α (0<α<1) controls the peak height of the pre-emphasis; the weak versus strong signal delay τ (typically within ±1 bit period) controls the peak location (more accurately, the periodicity in frequency domain) of the pre-emphasis.

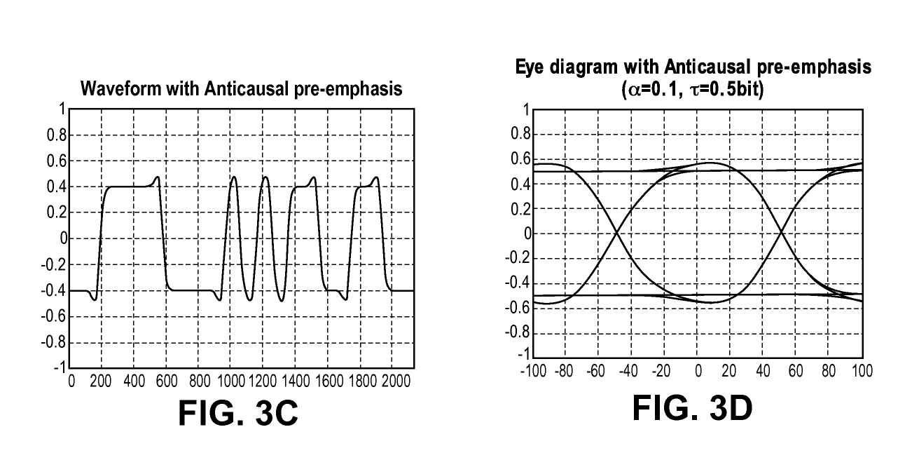

When the weak signal is late (τ>0), the pre-emphasis is causal: the waveform will overshoot or undershoot after a transition as shown in FIG. 3A and FIG. 3B. Note in this case, the pre-emphasis is at after each transition.

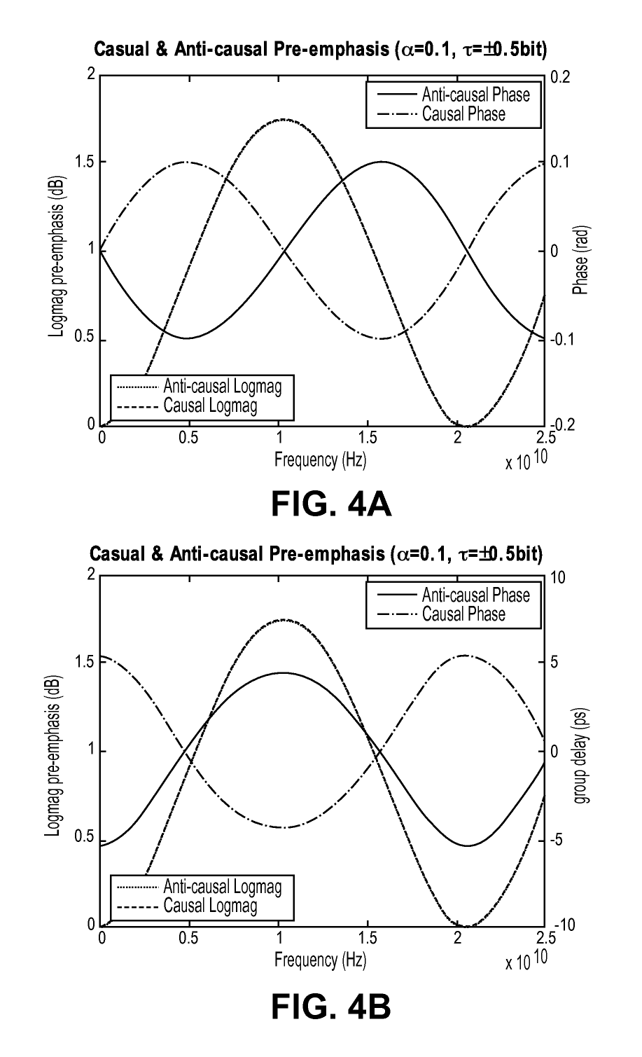

When the strong signal is late (τ<0), the pre-emphasis is anti-causal: the waveform will overshoot or undershoot prior to a transition as shown in FIG. 3C and FIG. 3D. Causal and anti-causal pre-emphasis with the same α and τ of opposite signs have transfer functions of identical magnitude. Their phase and group delay, however, are complementary as illustrated in FIG. 4A and FIG. 4B. The causal pre-emphasis is similar to the pre-emphasis achieved thru passive filtering (e.g. with a simple RC circuit), which is intrinsically causal. This effect would aggravate the optical eye asymmetry and degrade eye MM.

According to embodiments, the proposed method for optical transmitter pre-emphasis in this invention is anti-causal pre-emphasis. It counteracts the effect of relaxation oscillation, and therefore brings improvements to optical eye symmetry and MM, so long as the magnitude of peaking is not excessive. This type of pre-emphasis can not be implemented with a passive filter, but it can be readily implemented in a driver circuit. The parameters (α and τ) should be optimized based on the type of laser used, the data rate and the characteristic of the link.

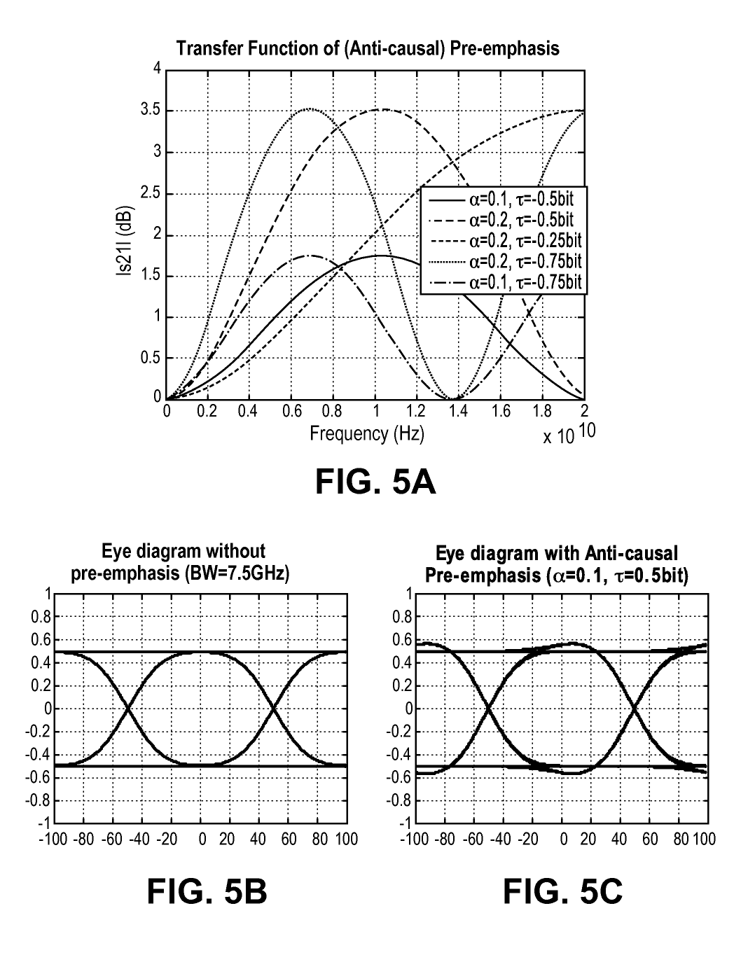

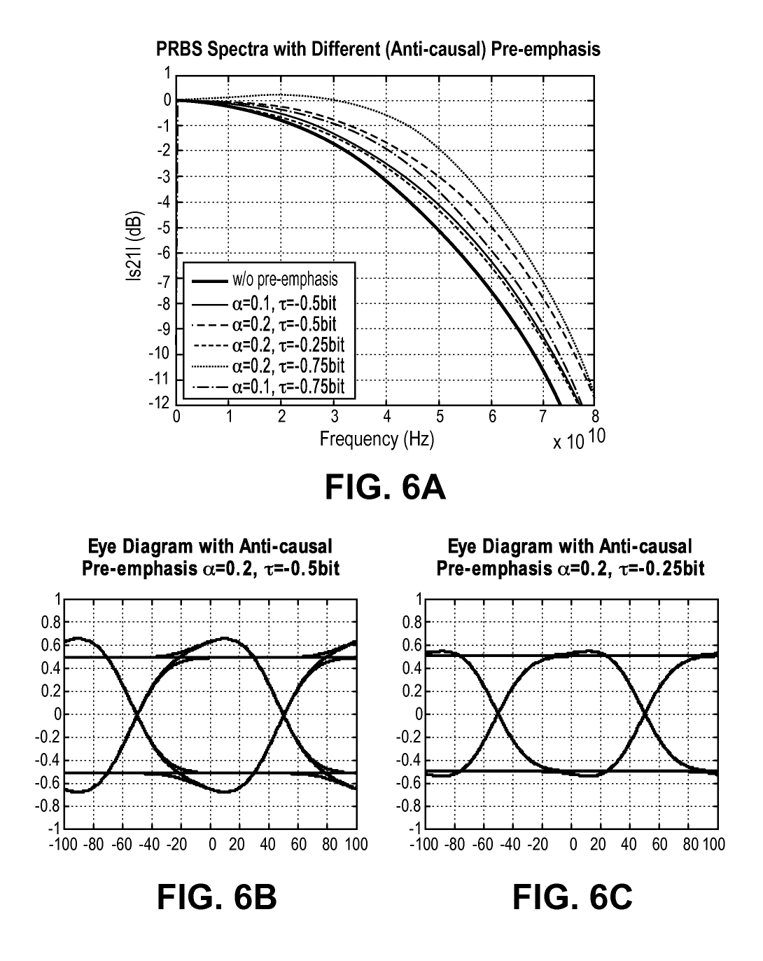

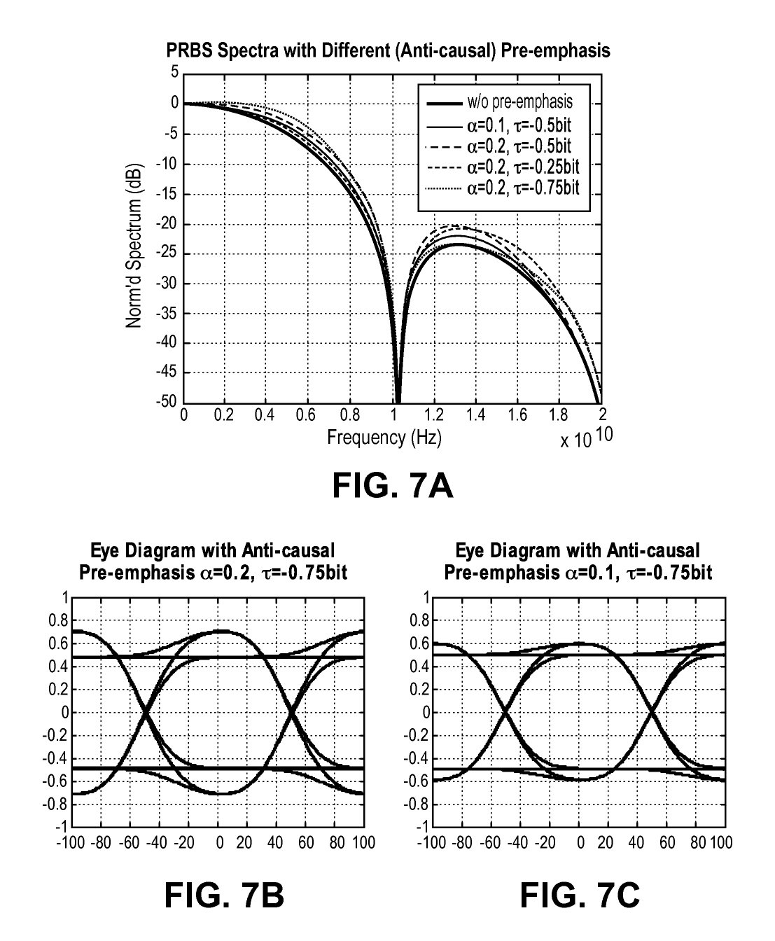

FIGS. 5A, 6A, and 7A show graph various transfer functions for anti-causal pre-emphasis for various values of α and τ. As noted above various parameters of these values may be appropriate and selected based on the various equipment and operational characteristics of the link. FIG. 5A shows transfer function (log magnitude) of pre-emphasis verse α and τ. FIG. 6A shows PRBS pattern spectra with different pre-emphasis. Finally, FIG. 7A shows the same as FIG. 6A but with a wider frequency range.

FIG. 5B and 5C show the eye diagram without pre-emphasis for a BW of 7.5 GHz signal and the eye diagram with anti-causal pre-emphasis for α=0.1 and τ=0.5 bit), respectively.

FIG. 6B and 6C show an eye diagram with anti-causal pre-emphasis for α=0.2 and τ=0.5 bit and the eye diagram with anti-causal pre-emphasis for α=0.2 and τ=−0.25 bit, respectively.

FIG. 7B and 7C show an eye diagram with anti-causal pre-emphasis for α=0.2 and τ=−0.75 bit and the eye diagram with anti-causal pre-emphasis for α=0.1 and τ=−0.75 bit, respectively.

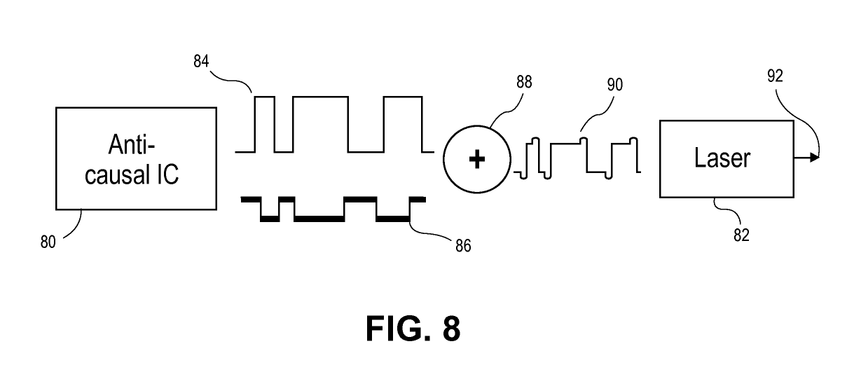

FIG. 8 shows a proof-of-concept experiment that was performed to demonstrate the benefits of anti-causal pre-emphasis for a laser TX system. The signal source 80 to generate the anti-causal waveforms was an Anritsu PPG. The optical transmitter is an 850 nm vertical cavity surface emitting laser (VCSEL) 82 based cathode driven TOSA. The input waveform 84 is processed by the signal source 80 with the pre-emphasis parameters are estimated to be α=0.124; τ=0.5 bit to yield the anti-causal waveform 86 which when combined at 88 gives the anti-causal pre-emphasis waveform 90 as input to the laser 82 to be output over a fiber link 92.

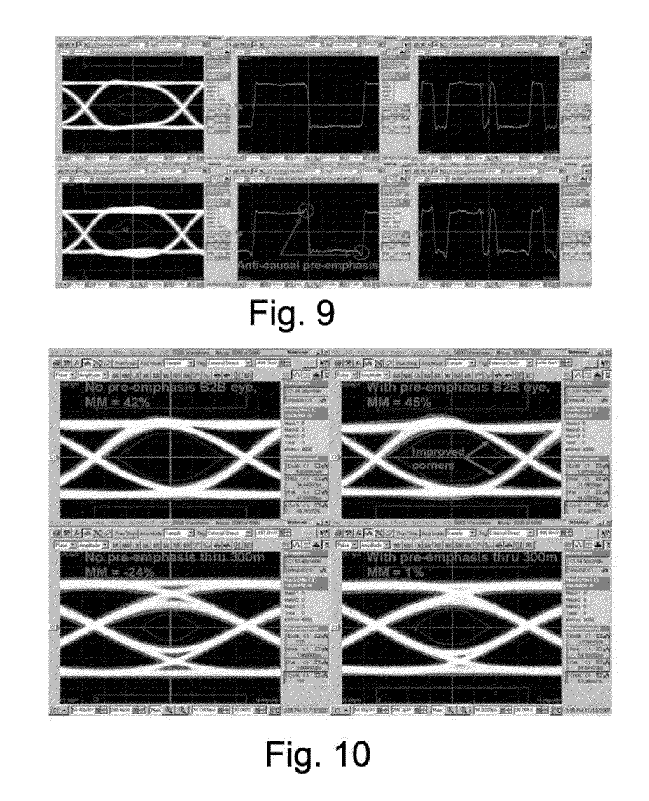

FIG. 9 shows the electrical signals from the bias-T with (bottom) and without (top) pre-emphasis. The anti-causal signatures are clearly visible. FIG. 10 compares the optical eye diagrams with (right) and without (left) pre-emphasis. The before fiber eye has improved MM; the after fiber eye has significantly better vertical opening.

The advantage of using an anti-causal pre-emphasized signal to drive a high speed optical transmitter is that it lowers link penalty without sacrificing optical eye mask margin. Conventional Tx pre-emphasis (intrinsically causal) needs to trade off MM for better link performance.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
an input to receive an data signal S(t);
an anti-causal filter to process the first signal S(t) to create a second signal αS(t+τ) being the inverse of the first signal, where α modifies the amplitude of the second signal and τ modifies a delay of the second signal;
a combiner to combine the first signal and the second signal to output an anti-causal pre-emphasis signal to be input to a laser.

2. The apparatus as recited in claim 1 wherein α is between 0.1. and 0.2.

3. The apparatus as recited in claim 1 wherein τ<0.

4. The apparatus as recited in claim 1 wherein the laser comprises a Transmitter Optical Subassembly (TOSA).

5. The apparatus as recited in claim 1 wherein τ comprises a negative fraction of a bit.

6. The apparatus as recited in claim 1 wherein the anti-causal filter selects any of a plurality of values for r and a optimized for a particular application.

7. A method, comprising:
receiving an input to receive an data signal S(t);
processing the data signal S(t) with an anti-causal filter to create a second signal αS(t+τ) being the inverse of the first signal S(t), where α modifies the amplitude of the second signal and τ modifies a delay of the second signal;
combining the first signal and the second signal to output an anti-causal pre-emphasis signal to be input to a laser.

8. The method as recited in claim 7 wherein α is between 0.1. and 0.2.

9. The method as recited in claim 7 wherein τ<0.

10. The method as recited in claim 7 wherein the laser comprises a Transmitter Optical Subassembly (TOSA).

11. The method as recited in claim 7 wherein τ comprises a negative fraction of a bit.

12. The apparatus as recited in claim 7 wherein the anti-causal filter selects any of a plurality of values for τ and α optimized for a particular application.

13. A high speed optical transmitter system, comprising:
a laser to output a signal over a fiber link;
an anti-causal filter to receive an data signal S(t), wherein the anti-causal filter to processes the first signal S(t) to create a second signal αS(t+τ) being the inverse of the first signal, where α modifies the amplitude of the second signal and τ modifies a delay of the second signal;
a combiner to combine the first signal and the second signal to output an anti-causal pre-emphasis signal to be input to the laser.

14. The high speed optical transmitter system as recited in claim 13 wherein α is between 0.1. and 0.2.

15. The high speed optical transmitter system as recited in claim 13 wherein τ<0.

16. The high speed optical transmitter system as recited in claim 13 wherein the laser comprises a Transmitter Optical Subassembly (TOSA).

17. The high speed optical transmitter system as recited in claim 13 wherein τ comprises a negative fraction of a bit.

18. The high speed optical transmitter system as recited in claim 13 wherein the anti-causal filter selects any of a plurality of values for τ and α optimized for a particular application.
